(19) United States
(12) Patent Application Publication
(10) Pub. No.: US 2012/0120044 A1
(43) Pub. Date: May 17, 2012

(54) LIQUID CRYSTAL DISPLAY DEVICE AND METHOD FOR DRIVING THE SAME

(75) Inventors: Takayuki Mizunaga, Osaka (JP); Hideki Morii, Osaka (JP); Akihisa Iwamoto, Osaka (JP); Yuuki Ohta, Osaka (JP); Kei Ikuta, Tottori (JP)

(73) Assignee: SHARP KABUSHIKI KAISHA, Osaka-shi, Osaka (JP)

(21) Appl. No.: 13/380,375

(22) PCT Filed: Jan. 27, 2010
(86) PCT No.: PCT/JP2010/051026

§ 371 Date: Jan. 25, 2012

(30) Foreign Application Priority Data
Jun. 22, 2009 (JP) 2009-147188

(51) Int. Cl. G09G 5/00

(52) U.S. Cl. 345/211

(57) ABSTRACT

Provided is a liquid crystal display device performing a precharge and having a function of switching an order for selecting scanning lines, in which such as flicker and burn-in can be prevented from being produced. A scanning line drive circuit selects scanning lines either in ascending order or in descending order based on an order of arrangement according to a shift direction signal, and causes selection periods of the scanning lines to be partially overlapped for a precharge. A data line drive circuit applies voltages of different polarities to data lines by frame and by data line. A common voltage generating circuit generates two types of voltages whose levels are independently adjustable, selects one of the two voltages according to a scan selection signal and applies the selected voltage to a common electrode of a liquid crystal panel. As the common voltage generating circuit, a D/A converter may be used.

### TECHNICAL FIELD

The present invention relates to liquid crystal display devices, and in particular to a liquid crystal display device capable of precharging a pixel capacitance.

### BACKGROUND ART

In liquid crystal display devices of recent years, a single line period (one horizontal period) is reduced as definition becomes increasingly higher, and this poses a problem that write time to pixel circuits cannot be sufficiently ensured. As one method for solving this problem, a method of partially overlapping selection periods of scanning lines and precharging a pixel capacitance is known.

FIG. 13 is a timing chart showing changes of voltages of scanning lines and data lines in a liquid crystal display device that performs a precharge. In the following description, P(i, j) represents a pixel circuit connected to a scanning line Gi and a data line Sj, and a voltage of a scanning line is controlled to a high level in a selection period for the scanning line. Referring to FIG. 13, a time period from a time point T1 to a time point T3 corresponds to a selection period for a scanning line Gi−1. The voltage of the scanning line Gi changes to a high level at a time point T2 within the selection period for the scanning line Gi−1. Accordingly, a capacitance of a pixel circuit P(i−1, j) is charged and a capacitance of the pixel circuit P(i, j) is preliminary charged by the voltage applied to the data line Sj from the time point T2 to the time point T3 (a voltage corresponding to video data D(i−1, j)).

When the voltage of the scanning line Gi−1 changes to a low level at the time point T3, writing to the pixel circuit P(i−1, j) ends. At and after the time point T3, the data line Sj is applied with the voltage corresponding to video data D(i, j). When the voltage of the scanning line Gi changes to a low level at time point T4, writing to the pixel circuit P(i, j) ends. With this, the voltage corresponding to the video data D(i, j) is written to the pixel circuit P(i, j). In this manner, performing a precharge by causing the selection periods of the scanning lines to be partially overlapped can increase the write time to each pixel circuit to perform the writing correctly even when a large number of scanning lines are provided.

Further, it is often required for a liquid crystal display device to switch an order of selection of the scanning lines (hereinafter referred-to-as-a scanning direction). For example, when using liquid crystal display devices, there are cases in which liquid crystal display devices of the same type are provided such that one is disposed in one direction and the other in a direction upside down of the one direction, and in which a liquid crystal screen of a portable electronic device displays an image by switching between a normal image and an image upside down of the normal image. According to a liquid crystal display device having a function of switching the scanning direction, it is possible to easily cope with such cases only by switching the scanning direction of the liquid crystal display device without inputting video signals in an order upside down.

It should be noted that, in connection with the invention of the present application, Patent Document 1 describes a display device capable of reducing flicker and burn-in by applying an optimal counter voltage to a counter electrode according to changes of an ambient temperature and an ambient light intensity.

### Prior Art Document

### Patent Document

[Patent Document 1] Japanese Laid-Open Patent Publication No. 2005-292493

### SUMMARY OF THE INVENTION

### Problems to be Solved by the Invention

Providing a function of switching a scanning direction for a liquid crystal display device that performs a precharge without any special contrivance poses a problem of producing flicker and burn-in in a display screen. This is explained in the following description taking a liquid crystal display device provided with a pixel circuit shown in FIG. 14. In the pixel circuits shown in FIG. 14, N represents a node to which a drain electrode of a TFT (Thin Film Transistor) 1 is connected. In the pixel circuit, a parasitic capacitance 4 is present between the node N and the scanning line Gi, and a parasitic capacitance 5 is present between the node N and the scanning line Gi+1.

When the scanning lines Gi are selected in ascending order (see FIG. 15A), a voltage at the node N connected to the scanning line Gi via the parasitic capacitance 4 drops by ΔV1 expressed by Expression 1 at time points Ta1 and Ta3 at which the voltage of the scanning line Gi changes to a low level. Then, the voltage at the node N connected to the scanning line Gi+1 via the parasitic capacitance 5 further drops by ΔV2 expressed by Expression 2 at time points Ta2 and Ta4 at which the voltage of the scanning line Gi+1 changes to a low level. As a result, the voltage at the node N drops by (ΔV1+ΔV2) from a level upon completion of the writing.

ΔV1=Cgd1×(VGH−VGL)/(Clc+Ccs+Cgd1+Cgd2) (1)

ΔV2=Cgd2×(VGH−VGL)/(Clc+Ccs+Cgd1+Cgd2) (2)

Here, in Expression 1, Clc is a capacitance value of a liquid crystal capacitance 2, Ccs is a capacitance value of an auxiliary capacitance 3, Cgd1 is a capacitance value of the parasitic capacitance 4, Cgd2 is a capacitance value of the parasitic capacitance 5, VGH is a high-level voltage applied to a scanning line, and VGL is a low-level voltage applied to the scanning line.

By contrast, when the scanning lines Gi are driven in descending order (see FIG. 15B), as the voltage of the scanning line Gi is in a high level and the TFT 1 is in an ON state at time points Tb1 and Tb3 at which the voltage of the scanning line Gi+1 changes to a low level, the voltage at the node N does not change even when the node N is connected to the scanning line Gi+1 via the parasitic capacitance 5. Then, the voltage at the node N connected to the scanning line Gi via the parasitic capacitance 4 drops by ΔV1 expressed by Expression 1 at time points Tb2 and Tb4 at which the voltage of the scanning line Gi changes to a low level. As a result, the voltage at the node N drops by ΔV1 from the level upon completion of the writing.

When the scanning direction is switched in a liquid crystal display device that performs a precharge in this manner, a voltage written to the pixel circuit (the voltage at the node N) includes a difference of ΔV2, and an optimal value of a common voltage VCOM also includes a difference of ΔV2. Accordingly, in the case where the common voltage VCOM is determined, for example, such that effective values of voltages applied to the liquid crystals during positive voltage application and during negative voltage application are equal (such that VPa=VMa in FIG. 15A) when the scanning lines Gi are selected in ascending order, a difference appears between effective values of voltages applied to the liquid crystals during positive voltage application and during negative voltage application (VPb≠VMb in FIG. 15B) when the scanning lines Gi are selected in descending order. As the common voltage VCOM differs from the optimal value in this manner, flicker or burn-in is produced in the display screen.

Therefore, an object of the present invention is to provide a liquid crystal display device performing a precharge and having a function of switching a scanning direction, in which such as flicker and burn-in can be prevented from being produced.

### Means for Solving the Problems

According to a first aspect of the present invention, there is provided a liquid crystal display device that perform a precharge, the device including: a liquid crystal panel including a plurality of scanning lines, a plurality of data lines, a plurality of pixel circuits, and a common electrode; a scanning line drive circuit configured to select the scanning lines in a specified direction according to an order of arrangement; a data line drive circuit configured to apply a voltage to each of the data lines, the voltage being according to a video signal; and a common voltage generating circuit configured to generate a common voltage to be applied to the common electrode, wherein the scanning line drive circuit causes selection periods of the scanning lines to be partially overlapped in order to precharge, and the common voltage generating circuit switches a level of the common voltage according to an order of the selection of the scanning lines.

According to a second aspect of the present invention, in the first aspect of the present invention, the common voltage generating circuit generates a plurality of voltages whose levels are independently adjustable, and outputs one of the generated voltages according to the order of the selection of the scanning lines as the common voltage.

According to a third aspect of the present invention, in the first aspect of the present invention, the common voltage generating circuit includes a D/A converter configured to output an analog voltage corresponding to an inputted digital value as the common voltage.

According to a fourth aspect of the present invention, in the first aspect of the present invention, the data line drive circuit applies voltages of different polarities to the data lines by line.

According to a fifth aspect of the present invention, in the first aspect of the present invention, the pixel circuits are classified into a plurality of types according to display colors, the pixel circuits of the same type are arranged along a direction in which the scanning lines extend.

According to a sixth aspect of the present invention, there is provided a method of driving a liquid crystal display device provided with a plurality of scanning lines, a plurality of data lines, a plurality of pixel circuits, and a common electrode, the method including the steps of: selecting the scanning lines in a specified direction according to an order of arrangement; applying a voltage to each of the data lines, the voltage being according to a video signal; and generating a common voltage to be applied to the common electrode, wherein in the step of selecting the scanning lines, selection periods of the scanning lines are caused to be partially overlapped in order to precharge, and in the step of generating the common voltage, a level of the common voltage is switched according to an order of the selection of the scanning lines.

### Effects of the Invention

According to one of the first and sixth aspects of the present invention, by switching the level of the common voltage according to the order of the selection of the scanning lines, an optimal common voltage can be always applied to the common electrode of the liquid crystal panel regardless of the order of the selection of the scanning lines. Therefore, it is possible to prevent such as flicker and burn-in from being produced in the liquid crystal display device performing a precharge and having a function of switching the order of the selection of the scanning lines.

According to the second aspect of the present invention, by the common voltage generating circuit generating the plurality of voltages whose levels are independently adjustable, it is possible to generate the common voltage that is most suitable according to characteristics of the liquid crystal panel, and to prevent such as flicker and burn-in from being produced.

According to the third aspect of the present invention, as the common voltage is generated using the D/A converter, simply by changing the digital value inputted to the D/A converter, it is possible to generate the common voltage that is most suitable according to characteristics of the liquid crystal panel, and to prevent such as flicker and burn-in from being produced.

According to the fourth aspect of the present invention, by precharging while causing the selection periods of the scanning lines to be partially overlapped, and by applying the voltages of different polarities to the data lines by line, it is possible to effectively precharge the pixel capacitances.

According to the fifth aspect of the present invention, in a case where the color liquid crystal display device in which the pixel circuits corresponding to the same display color are arranged along the direction in which the scanning lines extend performs a precharge and switches the order of selection of the scanning lines, it is possible to prevent such as flicker and burn-in from being produced.

### BRIEF DESCRIPTION OF THE DRAWINGS

FIG. 1 is a block diagram illustrating a configuration of a liquid crystal display device according to a first embodiment of the present invention.

FIG. 2 is a diagram illustrating an arrangement of pixels of a liquid crystal panel included in the liquid crystal display device shown in FIG. 1.

FIG. 3 shows diagrams illustrating polarities of voltages written to pixel circuits in the liquid crystal display device shown in FIG. 1.

FIG. 4A is a timing chart when scanning lines are selected in ascending order in the liquid crystal display device shown in FIG. 1.

FIG. 4B is a timing chart when the scanning lines are selected in descending order in the liquid crystal display device shown in FIG. 1.

FIG. 5 is a circuit diagram of a common voltage generating circuit included in the liquid crystal display device shown in FIG. 1.

FIG. 6 is a signal waveform diagram showing a change in the voltage written to the pixel circuit and switching of a common voltage in the liquid crystal display device shown in FIG. 1.

FIG. 7 is a block diagram illustrating a configuration of a liquid crystal display device according to a second embodiment of the present invention.

FIG. 8 is a table showing association among a scan selection signal, an input value of a D/A converter, and a common voltage in the liquid crystal display device shown in FIG. 7.

FIG. 9 is a table showing association among a scan selection signal, an input value of a D/A converter, and a common voltage in a modified example of the liquid crystal display device according to the second embodiment of the present invention.

FIG. 10 is a diagram illustrating an arrangement of pixels of a liquid crystal panel included in a modified example of the liquid crystal display device according to the present invention.

FIG. 11 shows diagrams illustrating polarities of voltages written to pixel circuits in a modified example of the liquid crystal display device according to the present invention.

FIG. 12 is a diagram for explanation of an effect provided by performing a precharge in a liquid crystal display device that performs dot inversion driving.

FIG. 13 is a timing chart for a liquid crystal display device that performs a precharge.

FIG. 14 is a circuit diagram illustrating a pixel circuit in a liquid crystal display device.

FIG. 15A is a signal waveform diagram showing a change in the voltage written to the pixel circuit when the scanning lines are selected in ascending order in a conventional liquid crystal display device.

FIG. 15B is a signal waveform diagram showing a change in the voltage written to the pixel circuit when the scanning lines are selected in descending order in the conventional liquid crystal display device.

### MODE FOR CARRYING OUT THE INVENTION

### First Embodiment

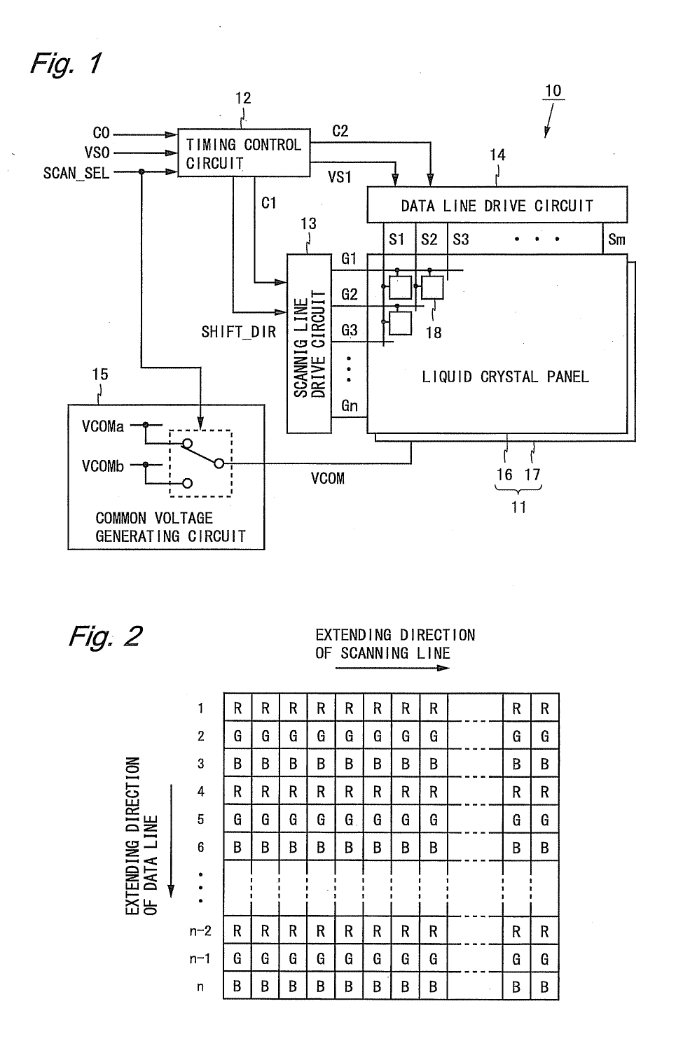

FIG. 1 is a block diagram illustrating a configuration of a liquid crystal display device according to a first embodiment of the present invention. A liquid crystal display device 10 shown in FIG. 1 is provided with a liquid crystal panel 11, a timing control circuit 12, a scanning line drive circuit 13, a data line drive circuit 14, and a common voltage generating circuit 15. In the following description, n is a multiple of 3, m is an integer not smaller than 2, i is an integer not smaller than 1 and not greater than n, and j is an integer not smaller than 1 and not greater than m.

The liquid crystal panel 11 has a structure in which a liquid crystal material is sandwiched between two glass substrates 16 and 17. On the one glass substrate 16, n scanning lines G1 to Gn, m data lines S1 to Sm, and (m×n) pixel circuits 18 are provided. The scanning lines Gi are arranged parallel to one another, and the data lines Sj are arranged parallel to one another and perpendicular to the scanning lines Gi. The pixel circuits 18 are provided at respective intersections between the scanning lines Gi and the data lines Sj, and each pixel circuit 18 is connected to one of the scanning lines Gi and one of the data lines Sj. Each pixel circuit 18 includes, as shown in FIG. 14, a TFT 1, a liquid crystal capacitance 2, and an auxiliary capacitance 3. However, the pixel circuit 18 does not necessarily include the auxiliary capacitance 3. On the other glass substrate 17, a common electrode (not depicted) that faces toward all of the pixel circuits 18 is provided. The common electrode is also referred to as a counter electrode.

To the liquid crystal display device 10, a control signal C0 and a video signal VS0 are externally inputted. The control signal C0 includes such as a vertical synchronization signal VSYNC and a horizontal synchronization signal HSYNC, for example. Based on the control signal C0, the timing control circuit 12 outputs a control signal C1 to the scanning line drive circuit 13, and a control signal C2 to the data line drive circuit 14. The control signal C1 includes such as a gate start pulse and a gate clock, for example, and the control signal C2 includes such as a source start pulse and a source clock, for example. Further, the timing control circuit 12 performs digital data correction processing (such as overdrive processing and independent gamma correction, for example) to the video signal VS0, and outputs a resulting video signal VS1 to the data line drive circuit 14. It should be noted that the timing control circuit 12 can output the video signal VS0 as the video signal VS1 without performing the digital data correction processing to the video signal VS0.

The scanning line drive circuit 13 sequentially selects the scanning lines Gi based on the control signal C1. More specifically, the scanning line drive circuit 13 selects one of the scanning lines G1 to Gn according to an order of arrangement based on the control signal C1, and applies a selection voltage (here, a high-level voltage) to the selected scanning line. The data line drive circuit 14 applies voltages corresponding to the video signal VS1 to the data lines Sj based on the control signal C2. In this case, the data line drive circuit 14 performs line sequential driving for applying voltages to m data lines Sj at the same time within a single line period. The common voltage generating circuit 15 generates a voltage to be applied to the common electrode of the liquid crystal panel 11 (hereinafter referred to as a common voltage VCOM).

By the scanning line drive circuit 13 selecting one of the scanning lines, the m pixel circuits 18 connected to the selected scanning line are selected all together. Further, the voltages applied to the data lines Sj are written to the m selected pixel circuits 18. A difference between the voltage written to each pixel circuit 18 and the common voltage VCOM corresponds to a voltage applied to the liquid crystal, and brightness of pixels included in the liquid crystal panel 11 changes according to the voltages applied to the liquid crystal. Therefore, it is possible to display a desired image in the liquid crystal panel 11 by writing the voltage corresponding to the video signal VS1 to each of the pixel circuits 18 using the scanning line drive circuit 13 and the data line drive circuit 14 while applying the common voltage VCOM generated by the common voltage generating circuit 15 to the common electrode.

FIG. 2 is a diagram illustrating an arrangement of the pixels of the liquid crystal panel 11. The pixel circuits 18 are classified according to display colors into R pixel circuits for displaying red, G pixel circuits for displaying green, and B pixel circuits for displaying blue. Referring to FIG. 2, the pixel circuits 18 corresponding to the same color are arranged adjacently along a direction in which the scanning lines Gi extend. Specifically, the R pixel circuits are arranged in a first line, a fourth line, and the like, the G pixel circuits are arranged in a second line, a fifth line, and the like, and the B pixel circuits are arranged in a third line, a sixth line, and the like. Three of the pixel circuits 18 that are arranged adjacently in a direction in which the data lines extend constitute a single pixel. The (m×n) pixel circuits 18 provided for the liquid crystal panel 11 corresponds to (m×(n/3)) pixels.

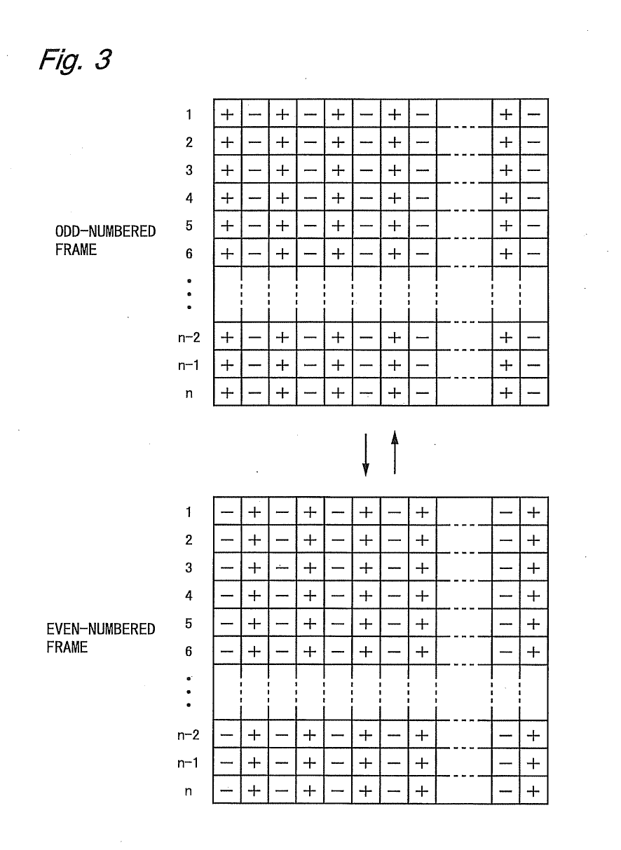

The liquid crystal display device 10 performs column inversion driving (also referred to as source line inversion driving) of switching the polarities of the voltages applied to the pixel circuits 18 by frame and by data line. FIG. 3 shows diagrams illustrating polarities of the voltages written to the pixel circuits 18. Referring to FIG. 3, in an odd-numbered frame, positive voltages are written to pixel circuits in an odd-numbered column, and negative voltages are written to pixel circuits in an even-numbered column. Further, in an even-numbered frame, negative voltages are written to the pixel circuits in the odd-numbered column, and positive voltages are written to the pixel circuits in the even-numbered column.

The liquid crystal display device 10 precharges a capacitance in each pixel circuit 18 by causing selection periods of the scanning lines Gi to be partially overlapped (details will be described later). Further, the liquid crystal display device 10 has a function of switching a scanning direction (an order for selecting the scanning lines Gi) as externally specified. A scan selection signal SCAN_SEL for specifying the scanning direction is externally inputted to the liquid crystal display device 10 along with the control signal CO and such. The scanning line drive circuit 13 is configured by a shift register capable of shifting bidirectionally. The timing control circuit 12 outputs a shift direction signal SHIFT_DIR for specifying a shifting direction of the shift register, based on the scan selection signal SCAN_SEL. The scanning line drive circuit 13 switches the shifting direction of the shift register according to the shift direction signal SHIFT_DIR.

It should be noted that the scanning line drive circuit 13 is not limited to that switches the shifting direction according to the shift direction signal SHIFT_DIR. For example, it is possible to configure a shift register capable of shifting bidirectionally using, as a circuit for each stage in the shift register, a circuit that transmits a signal outputted from a preceding circuit to a succeeding circuit, and transmits a signal outputted from the succeeding circuit to the preceding circuit. When using a scanning signal line drive circuit including such a shift register, the timing control circuit 12 is not required to output the shift direction signal SHIFT_DIR, and is only required to output a start signal to one of a first-stage circuit and a last-stage circuit according to the shifting direction, and

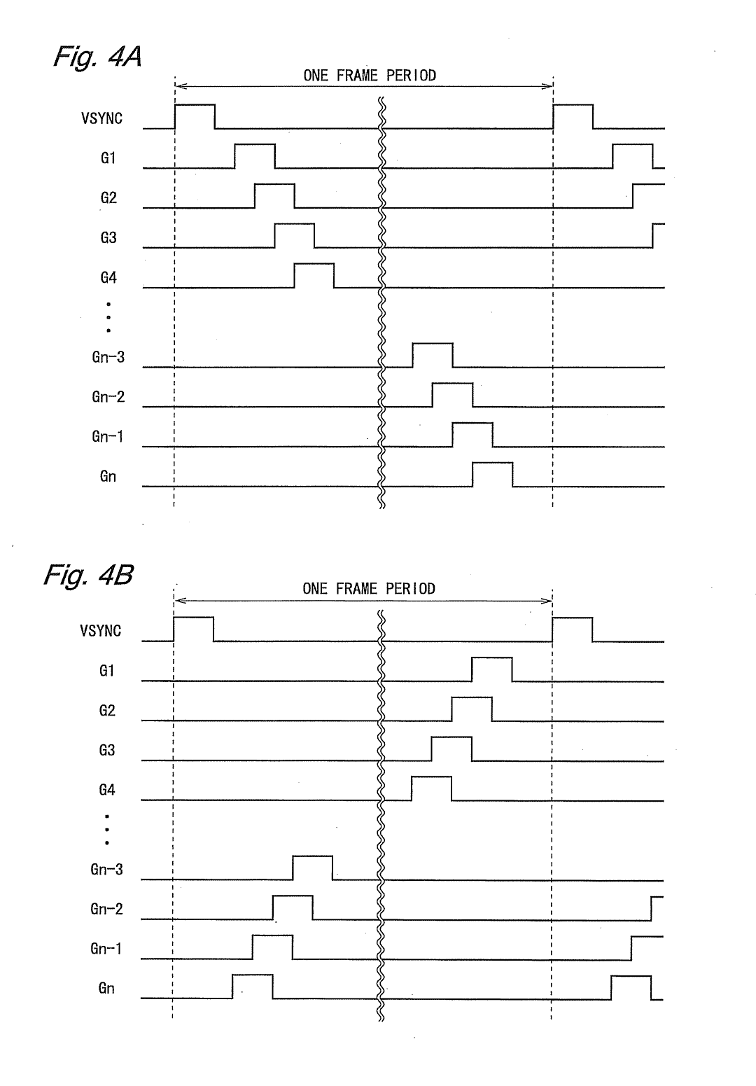

FIG. 4A is a timing chart of the liquid crystal display device 10 when the scan selection signal SCAN_SEL is in a low level. As shown in FIG. 4A, when the scan selection signal SCAN_SEL is in a low level, within one frame period, the voltage of the scanning line G1 first becomes a high level, the voltage of the scanning line G2 then becomes a high level, and the voltages of the remaining scanning lines become a high level in order of G3, G4, . . . , Gn−1, and Gn. In this manner, when the scan selection signal SCAN_SEL is in a low level, the scanning lines G1 to Gn are selected in ascending order.

FIG. 4B is a timing chart of the liquid crystal display device 10 when the scan selection signal SCAN_SEL is in a high level. As shown in FIG. 4B, when the scan selection signal SCAN_SEL is in a high level, within one frame period, the voltage of the scanning line Gn first becomes a high level, the voltage of the scanning line Gn−1 then becomes a high level, and the voltages of the remaining scanning lines become a high level in order of Gn−2, Gn−3, . . . , G2, and G1. In this manner, when the scan selection signal SCAN_SEL is in a high level, the scanning lines G1 to Gn are selected in descending order.

In either case, the selection period of the scanning line Gi overlaps with the selection periods of the adjacent scanning lines Gi−1 and Gi+1. Specifically, when the scan selection signal SCAN_SEL is in a low level (FIG. 4A), a former part of the selection period of the scanning line Gi overlaps with the selection period of the scanning line Gi−1, and a latter part of the selection period of the scanning line Gi overlaps with the selection period of the scanning line Gi+1. In this case, in the latter part of the selection period of the scanning line Gi−1, capacitances of the m pixel circuits 18 connected to the scanning line Gi are precharged. When the scan selection signal SCAN_SEL is in a high level (FIG. 4B), the former part of the selection period of the scanning line Gi overlaps with the selection period of the scanning line Gi+1, and the latter part of the selection period of the scanning line Gi overlaps with the selection period of the scanning line Gi−1. In this case, in the latter part of the selection period of the scanning line Gi+1, the capacitances of the m pixel circuits 18 connected to the scanning line Gi are precharged. Performing a precharge while performing the column inversion driving shown in FIG. 3, it is possible to increase the write time to the pixel circuits 18.

The scan selection signal SCAN_SEL is also supplied to the common voltage generating circuit 15. As described below, the common voltage generating circuit 15 switches the common voltage VCOM between two levels according to the scan selection signal SCAN_SEL.

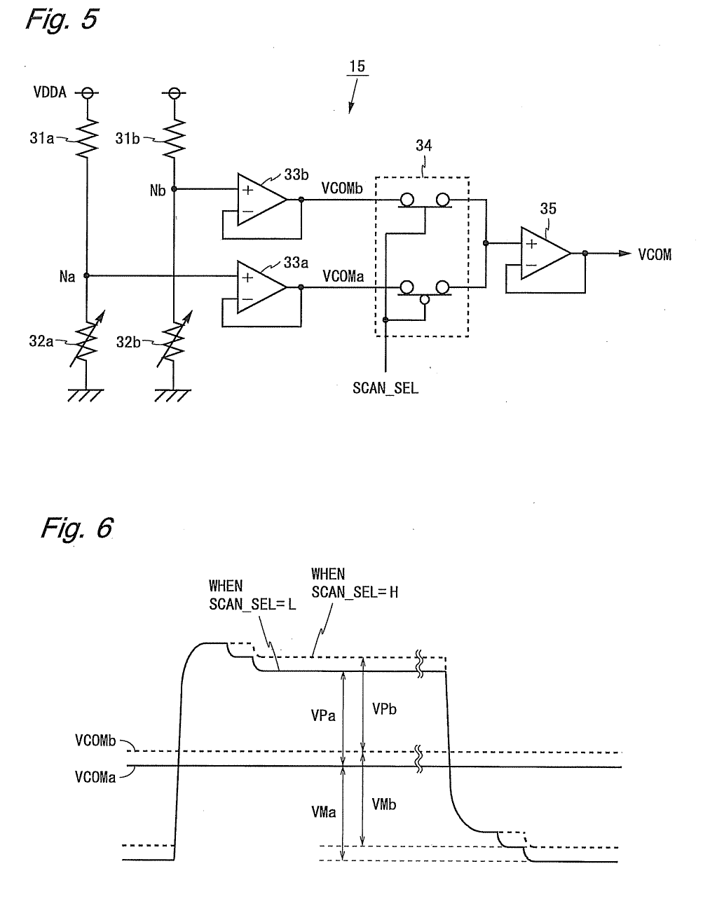

FIG. 5 is a circuit diagram of the common voltage generating circuit 15. The common voltage generating circuit 15 shown in FIG. 5 includes resistors 31a and 31b, variable resistors 32a and 32b, operational amplifiers 33a, 33b, and 35, and a switch circuit 34. Output terminals of the operational amplifiers 33a, 33b, and 35 are respectively connected to negative-side input terminals thereof, and each of the operational amplifiers 33a, 33b, and 35 functions as a unity gain amplifier.

The resistor 31a and the variable resistor 32a are connected in series, and provided between a power supply terminal to which an analog power-supply voltage VDDA is applied and a ground. The resistor 31b and the variable resistor 32b are provided in the same manner. A connecting point Na between the resistor 31a and the variable resistor 32a is connected to a positive-side input terminal of the operational amplifier 33a, and the operational amplifier 33a outputs a first common voltage VCOMa. A connecting point Nb between the resistor 31b and the variable resistor 32b is connected to a positive-side input terminal of the operational amplifier 33b, and the operational amplifier 33b outputs a second common voltage VCOMb. By adjusting resistance values of the variable resistors 32a and 32b, the first common voltage VCOMa and the second common voltage VCOMb are respectively set at suitable levels.

Two input terminals of the switch circuit 34 are connected to output terminals of the operational amplifiers 33a and 33b, respectively. Output terminals of the switch circuit 34 are connected to a positive-side input terminal of the operational amplifier 35, and the scan selection signal SCAN_SEL is inputted to a control terminal. When the scan selection signal SCAN_SEL is in a low level, the switch circuit 34 selects the first common voltage VCOMa, and the first common voltage VCOMa is outputted from the operational amplifier 35. When the scan selection signal SCAN_SEL is in a high level, the switch circuit 34 selects the second common voltage VCOMb, and the second common voltage VCOMb is outputted from the operational amplifier 35.

As described above, according to the scan selection signal SCAN_SEL, the common voltage generating circuit 15 shown in FIG. 5 selects and outputs one of the first common voltage VCOMa that is adjustable using the variable resistor 32a and the second common voltage VCOMb that is adjustable using the variable resistor 32b. The common voltage VCOM outputted from the common voltage generating circuit 15 is applied to the common electrode of the liquid crystal panel 11.

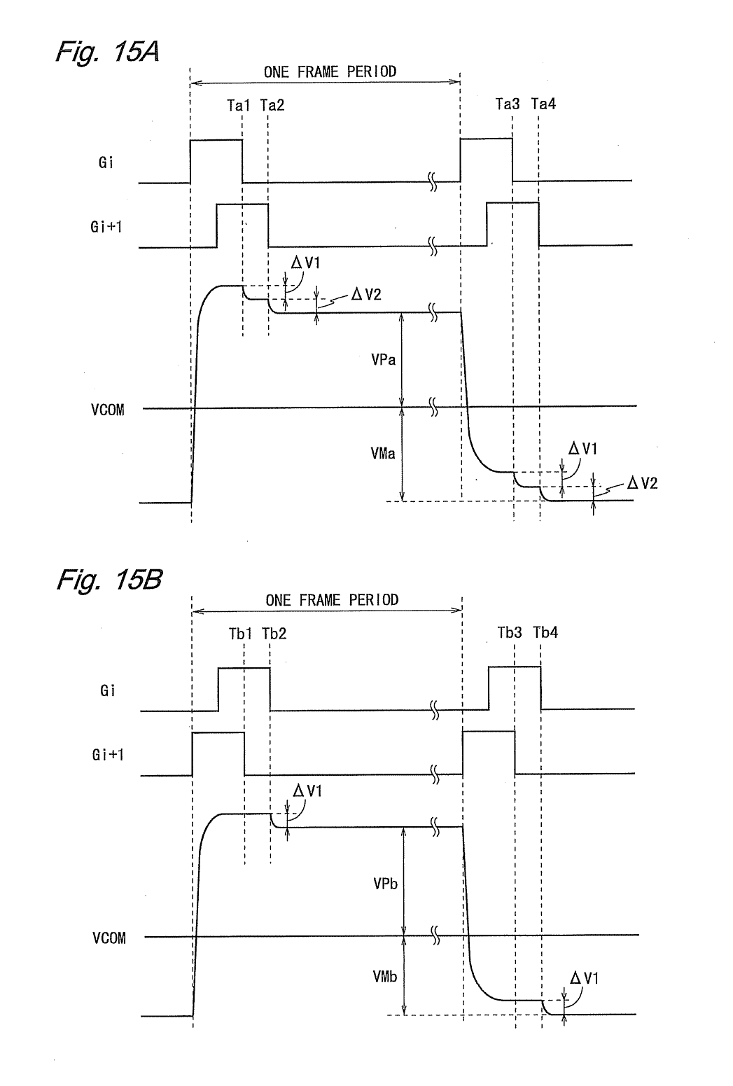

Effects of the liquid crystal display device 10 according to this embodiment are described with reference to FIG. 6. FIG. 6 is a signal waveform diagram showing a change in the voltage written to the pixel circuit 18 (a voltage of a drain electrode of the TFT in the pixel circuit 18) and switching of the common voltage VCOM in the liquid crystal display device 10. As described above, providing the function of switching the scanning direction for the liquid crystal display device that performs a precharge without any special contrivance produces flicker and burn-in in the display screen (see FIG. 15A and FIG. 15B, and the descriptions for the drawings).

Thus, in the liquid crystal display device 10 according to this embodiment, two types of the common voltages VCOMa and VCOMb are generated by the common voltage generating circuit 15, one of the common voltages VCOMa and VCOMb is selected according to the scan selection signal SCAN_SEL, and the selected voltage is applied to the common electrode of the liquid crystal panel 11. Therefore, when the scanning lines Gi are selected in ascending order, the first common voltage VCOMa that is suitable for this case can be applied, and when the scanning lines Gi are selected in descending order, the second common voltage VCOMb that is suitable for this case can be applied. The first common voltage VCOMa is determined such that when the scanning lines Gi are selected in ascending order, effective values of the voltages applied to the liquid crystals during positive voltage application and during negative voltage application are equal (such that VPa=VMa in FIG. 6). The second common voltage VCOMb is determined such that when the scanning lines Gi are selected in descending order, effective values of the voltages applied to the liquid crystals during positive voltage application and during negative voltage application are equal (such that VPb=VMb in FIG. 6).

Therefore, the optimal common voltage VCOM can be always applied to the common electrode of the liquid crystal panel 11 regardless of the scanning direction. Thus, it is possible to prevent such as flicker and burn-in from being produced in the display screen in the liquid crystal display device 10 performing a precharge and having the function of switching the scanning direction.

Further, by the common voltage generating circuit 15 generating the plurality of voltages VCOMa and VCOMb whose levels are independently adjustable, it is possible to generate the common voltage VCOM that is most suitable according to characteristics of the liquid crystal panel 11, and to prevent such as flicker and burn-in from being produced. Moreover, by performing a precharge while causing the selection periods of the scanning lines Gi to be partially overlapped, and by applying the voltages of different polarities to the data lines Sj by line, it is possible to effectively precharge the pixel capacitances. Furthermore, in a case where the color liquid crystal display device 10 in which the pixel circuits 18 corresponding to the same display color are arranged along the direction in which the scanning lines Gi extend performs a precharge and switches the order of selection of the scanning lines Gi, it is possible to prevent such as flicker and burn-in from being produced.

As described above, according to the liquid crystal display device 10 of this embodiment, it is possible to prevent such as flicker and burn-in from being produced in the liquid crystal display device performing a precharge and having the function of switching the scanning direction.

### Second Embodiment

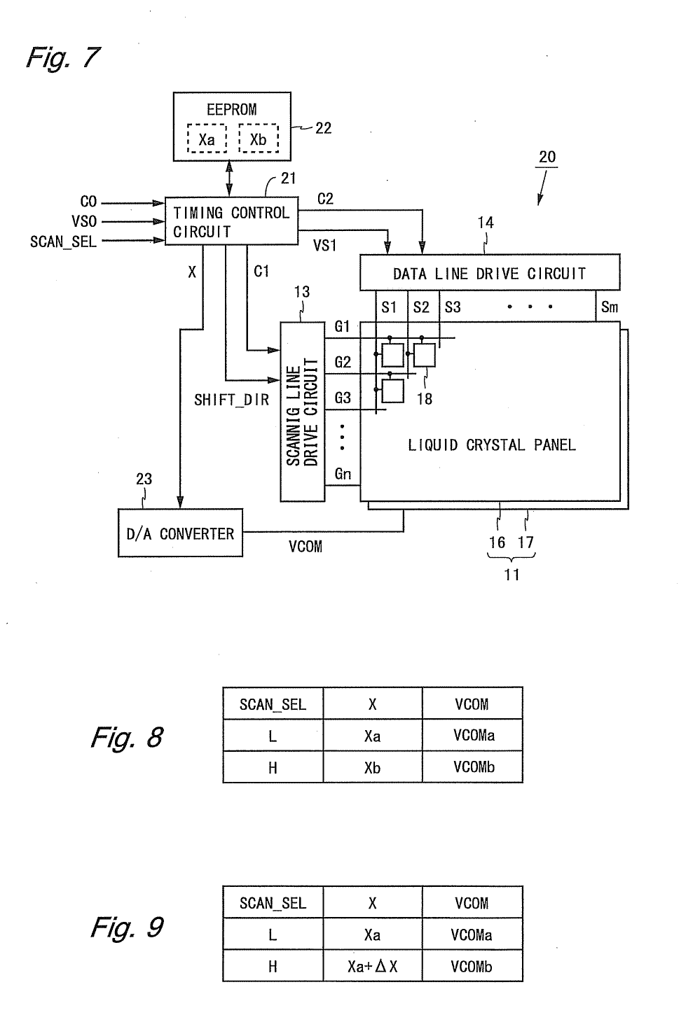

FIG. 7 is a block diagram illustrating a configuration of a liquid crystal display device according to a second embodiment of the present invention. A liquid crystal display device 20 shown in FIG. 7 is provided with the liquid crystal panel 11, a timing control circuit 21, the scanning line drive circuit 13, the data line drive circuit 14, an EEPROM (Electrically Erasable Programmable Read Only Memory) 22, and a D/A converter 23. In the liquid crystal display device 20, the D/A converter 23 functions as a common voltage generating circuit. Among the components in this embodiment, like components as in the first embodiment are represented by like reference numerals, and explanations for such components are omitted.

Similarly to the timing control circuit 12 according to the first embodiment, the timing control circuit 21, based on the control signal C0 and the video signal VS0, outputs the control signal C1 to the scanning line drive circuit 13, and the control signal C2 and the video signal VS1 to the data line drive circuit 14. In addition, the timing control circuit 21 also performs serial data transfer with the EEPROM 22, and with the D/A converter 23. When performing serial data transfer, for example, a scheme such as I2C (Inter-Integrated Circuit) or SPI (Serial Peripheral Interface) is employed.

The EEPROM 22 previously stores two digital values Xa and Xb, in order to switch the level of the common voltage VCOM according to the scanning direction. At power-on of the liquid crystal display device 20, the timing control circuit 21 performs serial data transfer with the EEPROM 22, and reads the two digital values Xa and Xb from the EEPROM 22 to store the read values in an internal register. Then, the timing control circuit 21 selects one of the two digital values Xa and Xb stored in the register according to the scan selection signal SCAN_SEL, and performs serial data transfer with the D/A converter 23 to output the selected digital value to the D/A converter 23.

The D/A converter 23 converts the digital value outputted from the timing control circuit 21 (hereinafter referred to as an input value X) into an analog voltage. As the D/A converter 23, any type of D/A converter can be used. Further, the D/A converter 23 may or may not include an operational amplifier therein. When using a D/A converter without an operational amplifier, an operational amplifier can be provided external to the D/A converter 23.

FIG. 8 is a table showing association among the scan selection signal SCAN_SEL, the input value X of the D/A converter 23, and the common voltage VCOM in the liquid crystal display device 20. Referring to FIG. 8, when the scan selection signal SCAN_SEL is in a low level, the timing control circuit 21 selects and outputs the digital value Xa, and the D/A converter 23 outputs an analog voltage corresponding to the digital value Xa. The analog voltage corresponding to the digital value Xa constitutes the first common voltage VCOMa. When the scan selection signal SCAN_SEL is in a high level, the timing control circuit 21 selects and outputs the digital value Xb, and the D/A converter 23 outputs an analog voltage corresponding to the digital value Xb. The analog voltage corresponding to the digital value Xb constitutes the second common voltage VCOMb.

In this manner, the D/A converter 23 selects and outputs one of the first common voltage VCOMa corresponding to the digital value Xa and the second common voltage VCOMb corresponding to the digital value Xb according to the scan selection signal SCAN_SEL. The common voltage VCOM outputted from the D/A converter 23 is applied to the common electrode of the liquid crystal panel 11.

The digital value Xa stored in the EEPROM 22 is determined such that the first common voltage VCOMa is an optimal common voltage when the scanning lines Gi are selected in ascending order. Similarly, the digital value Xb is determined such that the second common voltage VCOMb is an optimal common voltage when the scanning lines Gi are selected in descending order.

Therefore, according to the liquid crystal display device 20 of this embodiment, similarly to the liquid crystal display device 10 according to the first embodiment, it is possible to prevent such as flicker and burn-in from being produced in the liquid crystal display device performing a precharge and having the function of switching the scanning direction.

Further, as the common voltage VCOM is generated using the D/A converter 23, simply by changing the digital value X inputted to the D/A converter 23, it is possible to generate the common voltage VCOM that is most suitable according to characteristics of the liquid crystal panel 11, and to prevent such as flicker and burn-in from being produced.

It should be noted that modified examples described below can be obtained from the liquid crystal display device 20 according to this embodiment. While in the description above, the EEPROM 22 stores the two digital values Xa and Xb, the EEPROM can instead store a single digital value and a single offset value. In this case, the other digital value is obtained by the timing control circuit reading the digital value and the offset value from the EEPROM and performing addition or subtraction between the digital value and the offset value that have been read.

FIG. 9 is a table showing association among the scan selection signal SCAN_SEL, the input value X of the D/A converter, and the common voltage VCOM in this modified example of the liquid crystal display device. The digital value Xa and an offset value ΔX shown in FIG. 9 are stored in the EEPROM. The timing control circuit adds the offset value ΔX to the digital value Xa that have been read from the EEPROM to obtain the other digital value (Xa+ΔX). An analog voltage corresponding to the digital value Xa constitutes the first common voltage VCOMa, and an analog voltage corresponding to the digital value (Xa+ΔX) constitutes the second common voltage VCOMb.

Alternatively, the EEPROM may store only a single digital value. In this case, the other digital value is obtained by the timing control circuit adding or subtracting a predetermined offset value to or from the digital value that has been read from the EEPROM. According to the liquid crystal display device of this modified example, determining the first common voltage VCOMa automatically determines the second common voltage VCOMb. Therefore, it is possible to reduce time required for adjustment of the common voltage VCOM in an inspection step of the liquid crystal display device.

Further, in the above description, the timing control circuit 21 reads the two digital values Xa and Xb from the EEPROM 22, stores the read values in the internal register at power-on, and then selects one of the two digital values Xa and Xb stored in the register according to the scan selection signal SCAN_SEL. Instead, the timing control circuit may read only one of the digital values corresponding to the scan selection signal SCAN_SEL from the EEPROM 22, and output the read digital value to the D/A converter 23.

Moreover, the liquid crystal display devices 10 and 20 according to the first and the second embodiment have the arrangement of the pixels shown in FIG. 2, and perform column inversion driving shown in FIG. 3. Instead, the liquid crystal display device according to the present invention may have a different arrangement of the pixels, and switch the polarities of the voltages written to the pixel circuits according to a different method. In addition, the liquid crystal display device according to the present invention may perform a precharge according to timing other than the timing shown in FIG. 4A and FIG. 4B, as long as the scanning lines Gi are selected according to the order of arrangement.

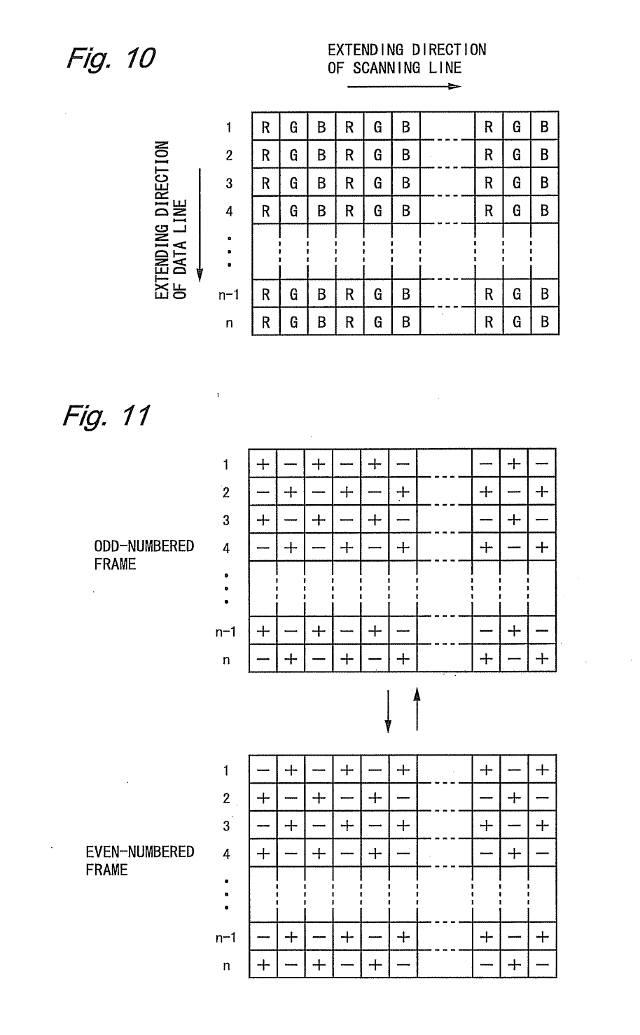

In particular, the present invention is not limited to a liquid crystal display device that applies pixel circuits with voltages of the same polarity as those applied to pixel circuits in a previous line while performing a precharge, and can be applied to a liquid crystal display device that applies pixel circuits with voltages of a polarity different from those applied to pixel circuits in a previous line while performing a precharge. For example, the liquid crystal display device according to the present invention may have the liquid crystal panel in which the pixel circuits corresponding to the same color are arranged along the direction in which the data lines Sj extend as shown in FIG. 10, or may perform dot inversion driving of switching the polarities of the voltages applied to the pixel circuits by frame and by pixel circuit as shown in FIG. 11.

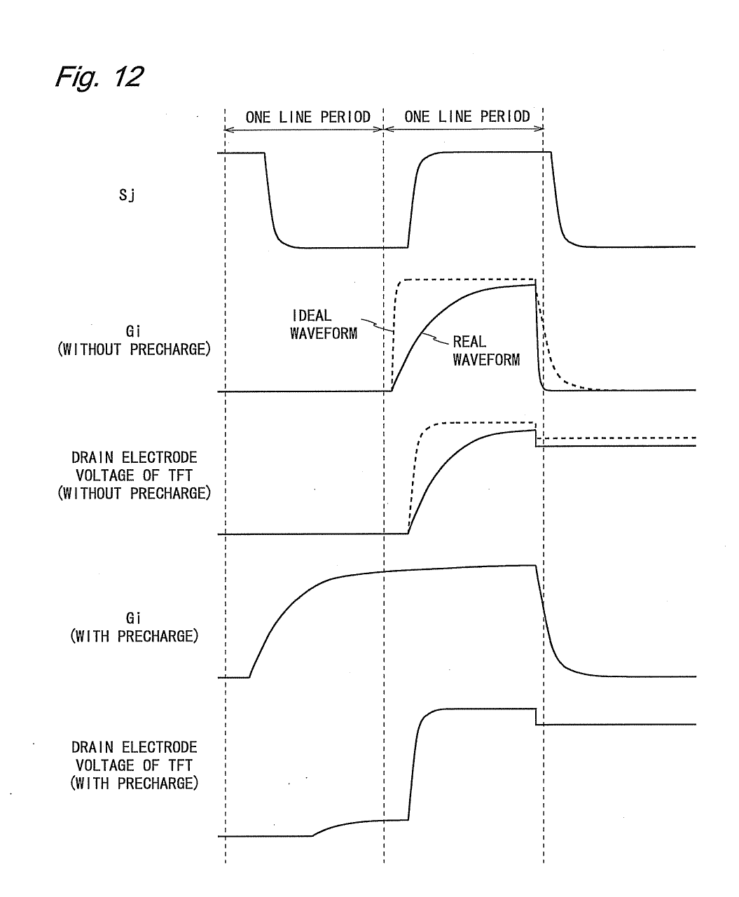

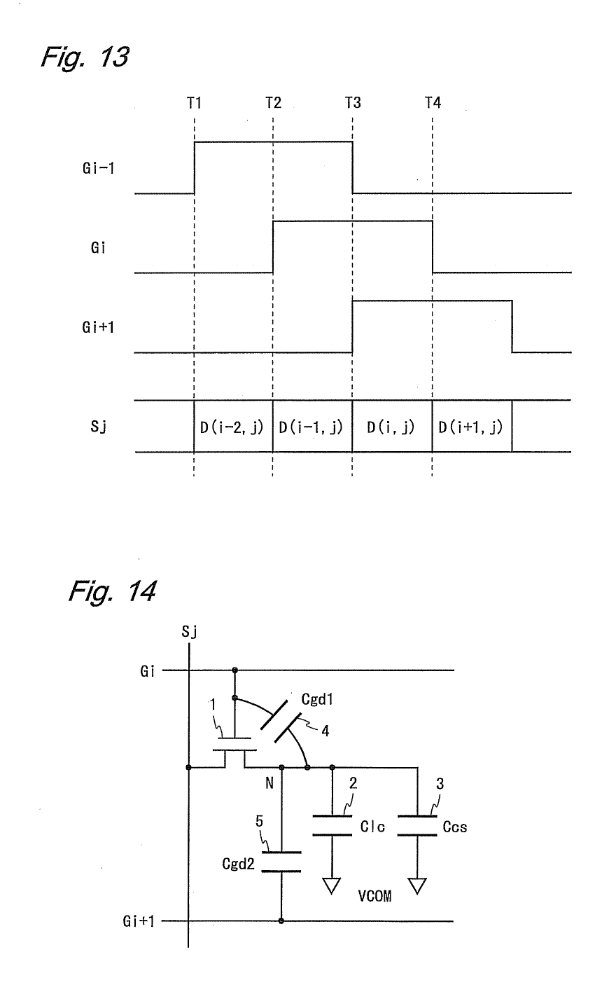

Effects of the precharge performed by the liquid crystal display device performing dot inversion driving are described with reference to FIG. 12. For example, if a size of the liquid crystal panel is large and the scanning lines are long, rise time of potential of the scanning line delays at a position distant from the scanning line drive circuit. Accordingly, as the potentials of the scanning lines rise slowly although potentials of the data lines change quickly, there is often a case in which the voltage of the drain electrode of the TFT in each pixel circuit does not reach a target level within a single line period (see second and third waveforms in FIG. 12). This phenomenon also occurs when the performance of the scanning line drive circuit is not sufficient as a size of transistors formed on the liquid crystal panel monolithically formed with the scanning line drive circuit is limited.

In such a case, by precharging the pixel circuits while the selection periods of the scanning lines are caused to be partially overlapped, the voltage of the drain electrode of the TFT also changes along with the change of the potentials of the data lines, and therefore it is possible to cause the voltage to reach the target level in a short period of time (see fourth and fifth waveforms in FIG. 12). In general, the liquid crystal display device may apply the pixel circuits with voltages of the polarity different from those applied to the pixel circuits in a previous line while performing a precharge, and it is possible to apply the present invention to such a liquid crystal display device.

### INDUSTRIAL APPLICABILITY

The liquid crystal display device according to the present invention provides an advantageous effect of preventing such as flicker and burn-in from being produced for a display device performing a precharge and having a function of switching a scanning direction, and can be used for such as display units of various electronic devices.

### Description Of Reference Characters

10, 20: LIQUID CRYSTAL DISPLAY DEVICE

11: LIQUID CRYSTAL PANEL

12, 21: TIMING CONTROL CIRCUIT

13: SCANNING LINE DRIVE CIRCUIT

14: DATA LINE DRIVE CIRCUIT

15: COMMON VOLTAGE GENERATING CIRCUIT

16, 17: GLASS SUBSTRATE

18: PIXEL CIRCUIT

22: EEPROM

23: D/A CONVERTER

1. A liquid crystal display device that perform a precharge, the device comprising:
a liquid crystal panel including a plurality of scanning lines, a plurality of data lines, a plurality of pixel circuits, and a common electrode;
a scanning line drive circuit configured to select the scanning lines in a specified direction according to an order of arrangement;
a data line drive circuit configured to apply a voltage to each of the data lines, the voltage being according to a video signal; and
a common voltage generating circuit configured to generate a common voltage to be applied to the common electrode, wherein
the scanning line drive circuit causes selection periods of the scanning lines to be partially overlapped in order to precharge, and
the common voltage generating circuit switches a level of the common voltage according to an order of the selection of the scanning lines.

2. The liquid crystal display device according to claim 1, wherein
the common voltage generating circuit generates a plurality of voltages whose levels are independently adjustable, and outputs one of the generated voltages according to the order of the selection of the scanning lines as the common voltage.

3. The liquid crystal display device according to claim 1, wherein
the common voltage generating circuit includes a D/A converter configured to output an analog voltage corresponding to an inputted digital value as the common voltage.

4. The liquid crystal display device according to claim 1, wherein
the data line drive circuit applies voltages of different polarities to the data lines by line.

5. The liquid crystal display device according to claim 1, wherein
the pixel circuits are classified into a plurality of types according to display colors,
the pixel circuits of the same type are arranged along a direction in which the scanning lines extend.

6. A method of driving a liquid crystal display device provided with a plurality of scanning lines, a plurality of data lines, a plurality of pixel circuits, and a common electrode, the method comprising the steps of:
selecting the scanning lines in a specified direction according to an order of arrangement;
applying a voltage to each of the data lines, the voltage being according to a video signal; and
generating a common voltage to be applied to the common electrode, wherein
in the step of selecting the scanning lines, selection periods of the scanning lines are caused to be partially overlapped in order to precharge, and
in the step of generating the common voltage, a level of the common voltage is switched according to an order of the selection of the scanning lines.
